(19) United States
(12) Patent Application Publication
(10) Pub. No.: US 2024/0005216 A1
(43) Pub. Date: Jan. 4, 2024

(54) USING SECURE AND RELIABLE BENEFIT-ANALYSIS MATCHMAKING TO SELECT FEDERATED LEARNING CANDIDATES

(71) Applicant: International Business Machines Corporation, Armonk, NY (US)

(72) Inventors: Jayaram Kallapalayam Radhakrishnan, Pleasantville, NY (US); Vinod Muthusamy, Austin, TX (US); Ashish Verma, Nanuet, NY (US); Zhongshu Gu, Ridgewood, NJ (US); Gegi Thomas, Danbury, CT (US); Supriyo Chakraborty, White Plains, NY (US); Mark Purcell, Naas (IE)

(21) Appl. No.: 17/810,006

(22) Filed: Jun. 30, 2022

(51) Int. Cl. G06N 20/20; G06F 11/34; G06F 9/50

(52) U.S. Cl. CPC G06N 20/20; G06F 11/3495; G06F 9/5055

(57) ABSTRACT

Embodiments of the invention include a computer-implemented method that uses a processor system to access a first machine learning (ML) model. The first ML model has been trained using data of a first server. A first performance metric of the first ML model is determined using data of a second server. A benefit analysis is performed to determine a benefit of the first ML server and the second ML server participating in a federated learning system, where the benefit analysis includes using the first performance metric.

### BACKGROUND

The present invention relates in general to programmable computers. More specifically, the present invention relates to computer systems, computer-implemented methods, and computer program products operable to implement secure, reliable, and novel benefit-analysis matchmaking to identify and select federated learning candidates.

The terms “federated learning” describe a set of tools for training a common or global machine learning (ML) model collaboratively using local models that are trained using a federated set of secure local data sources. The local data sources are never moved or combined, but instead each local model is trained, and parameters of the local model are transmitted to a central aggregation server that fuses the local model parameters s to generate the common ML model. Federated learning is appropriate for situations where parties want to leverage their data without sharing their data. For example, an aviation alliance might want to model how a global health emergency impacts airline delays. Each party participating in the federation can use its data to train its own local ML model then send parameters of its locally trained ML models to an aggregation server that combines or fuses the received parameters of the local ML models to generate a common ML model. Parameters of the common ML model are returned back to each party and used to perform additional training, for example, in a multi-round ML process. This process is continued until the common ML model reaches a desired level of performance.

The term “matchmaking” is used in federated learning to describe, generally, processes for selecting candidates to participate in a federated learning system.

### SUMMARY

Embodiments of the invention include a computer-implemented method that uses a processor system to access a first machine learning (ML) model. The first ML model has been trained using data of a first server. A first performance metric of the first ML model is determined using data of a second server. A benefit analysis is performed to determine a benefit of the first ML server and the second ML server participating in a federated learning system, where the benefit analysis includes using the first performance metric.

Embodiments of the invention include a computer system and a computer program product having substantially the same features as the computer-implemented method described above.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 depicts a simplified block diagram illustrating a federated learning system having secure and reliable benefit-analysis matchmaking in accordance with embodiments of the invention;

FIG. 2 depicts a simplified block diagram illustrating a federated learning system developed using secure and reliable benefit-analysis matchmaking in accordance with embodiments of the invention;

FIG. 3 depicts a simplified block diagram illustrating a candidate evaluation system having secure and reliable benefit-analysis matchmaking in accordance with embodiments of the invention;

FIG. 4 depicts a flow diagram illustrating a computer-implemented method according to embodiments of the invention;

FIG. 5 depicts a flow diagram illustrating a computer-implemented method according to embodiments of the invention;

FIG. 6 depicts a simplified block diagram illustrating a candidate evaluation system having secure and reliable benefit-analysis matchmaking in accordance with embodiments of the invention;

FIG. 7 depicts a flow diagram illustrating a computer-implemented method according to embodiments of the invention;

FIG. 8 depicts a table or matrix illustrating secure and reliable benefit-analysis matchmaking in accordance with embodiments of the invention;

FIG. 9 depicts a table or matrix illustrating secure and reliable benefit-analysis matchmaking in accordance with embodiments of the invention;

FIG. 10 depicts a table or matrix illustrating secure and reliable benefit-analysis matchmaking in accordance with embodiments of the invention;

FIG. 11 depicts a table or matrix illustrating secure and reliable benefit-analysis matchmaking in accordance with embodiments of the invention;

FIG. 12 depicts details of an exemplary programmable computer system capable of implementing aspects of the invention;

FIG. 13 depicts a cloud computing environment according to embodiments of the present invention; and

FIG. 14 depicts abstraction model layers according to an embodiment of the present invention.

In the accompanying figures and following detailed description of the disclosed embodiments, the various elements illustrated in the figures are provided with three-digit reference numbers. The leftmost digit of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are relevant to aspects of the invention, traditional machine learning (ML) models achieve a relatively high model accuracy by training the ML model on a large corpus of training data. In a known ML configuration, a data pipeline feeds training data to a central server that hosts and trains the model to perform tasks such as making make predictions. A downside of this architecture is that all the data collected by local devices and/or sensors are sent back to the central server, which is not an option where the relevant training data must be kept confidential (e.g., personal medical records, private customer data, and the like).

Federated learning is an approach that downloads the current model and computes an updated model at the device itself (e.g., edge computing) using local data. The locally trained models are then sent from the local devices back to the central server where they are aggregated, for example, by averaging weights, and then a single consolidated and improved global model is sent back to the local devices. In a more general sense, federated learning allows ML algorithms to gain experience from a broad range of confidential data sets located at different locations. The approach enables multiple organizations to collaborate on the development of models, but without needing to directly share secure data with each other. Over the course of several training iterations, the shared models are exposed to a significantly wider range of data than any single entity possesses in-house. In other words, federated learning decentralizes ML by removing the need to pool data into a single location. Instead, the model is trained in multiple iterations at different locations.

For example, multiple parties (P) (e.g., hospitals) each has its own locally resident data involving personal and/or sensitive information (e.g., electronic medical record (EMR) data), and they would like to collectively use their data to build and train a global ML model having better model performance (e.g., accuracy) than each party's local ML model alone. A third party S is used to help the parties P build the global ML model by implementing a federated learning system. In an example federated learning system, each party P trains its own local ML model in a privacy-preserving way (to avoid leakage of sensitive inferences about its data) and sends parameters of its local ML model to party S. Party S collects the parameters of the local ML models from the parties P, uses the collected parameters to calculate the parameters for the global ML model, and sends the global ML model parameters back to the parties P for a new round of local ML model training based on the global ML model parameters. The global ML model is continuously updated in this fashion until, after several rounds, a desired model performance is reached. Party S then shares the global ML model with each party P for use on each party's private and locally held data.

The term “matchmaking” is used in federated learning to describe, generally, processes for selecting candidates to participate in a federated learning system. However, in addition to selecting federated learning candidates, there is also a need to incentivize federated learning candidates to participate in a proposed federated learning system.

Turning now to an overview of aspects of the invention, embodiments of the invention provide computer systems, computer-implemented methods, and computer program products operable to implement secure, reliable, and novel benefit-analysis matchmaking operations that identify well-matched federated learning candidates and generate candidate-benefit evidence, which can be used to incentivize the well-matched federated learning candidates to participate in a proposed federated learning job. The candidate-benefit evidence can also be used to identify differences in the amount of benefit that will be experienced by each candidate to equitably apportion costs among the candidates for setting up and maintaining the federation.

Aspects of the invention determine that two federated learning candidates are well-matched when their local data sets are sufficiently different from one another, or are sufficiently complementary to one another, that their federated common ML model will have meaningfully better performance than each candidate's non-federated local ML model operating alone. Even when the members of the federation have dissimilar data that results in model performance benefits, not all members of the federation will benefit equally from the federated learning. For example, some members may have significantly more data than other members. Also differences between the data distribution of each member of the federation can result in members experiencing different model performance benefits. Embodiments of the invention provide novel benefit-analysis matchmaking techniques that enable a secure and reliable analysis of the compatibility of local training data sets to generate candidate-benefit evidence without directly analyzing the local training data sets themselves or exposing/compromising the locally trained models. The candidate-benefit evidence can be organized in tables or matrices, and analysis such as similarity analysis and clustering can be used to identify well-matched federated learning candidates, as well as the difference in benefits that will flow to each of the well-matched federated learning candidates as a result of participating in the federated learning system.

In an example to illustrate aspects of the invention, assume that Party A and Party B are under evaluation to be participants in a federated learning system. In accordance with embodiments of the invention, Party A trains Party A's local ML model using Party A's confidential local training data. Party A then computes a “local” Party A performance metric of Party A's local ML model by determining or measuring the performance of its local ML model when making predictions on its local test data. In general, when training a ML model, data is partitioned uniformly into a training set and a test set. Party A securely transmits Party A's local ML model to Party B, and Party B determines a performance metric of Party A's local ML model using Party B's confidential local test data. Party B then computes a “remote” Party A performance metric of Party A's local ML model using Party B's confidential local test data. A benefit analysis is performed to determine a benefit of Party A and Party B participating in the same federated learning system, where the benefit analysis includes at least an evaluation of the remote Party A performance metric. In some embodiments of the invention, the benefit analysis includes at least an evaluation of the remote Party A performance metric and the local Party A performance metric.

Continuing with the above example, in some embodiments of the invention, Party B trains Party B's local ML model using Party B's confidential local training data. Party B then computes a local Party B performance metric of Party B's local ML model by determining or measuring the performance of its ML local model when making predictions on its local test data. Party B securely transmits Party B's local ML model to Party A, and Party A determines a performance metric of Party B's local ML model using Party A's confidential local test data. Party A then computes a remote Party B performance metric of Party B's local ML model using Party A's confidential local test data. The previously-described benefit analysis is performed to determine a benefit of Party B and Party A participating in the same federated learning system, where the benefit analysis includes at least an evaluation of the remote Party B performance metric. In some embodiments of the invention, the benefit analysis includes at least an evaluation of the remote Party B performance metric and the local Party B performance metric. In some embodiments of the invention, the benefit analysis includes at least an evaluation of the remote Party A performance metric, the remote Party B performance metric, the local Party A performance metric, and the local Party B performance metric.

In aspects of the invention, the performance metric can be any suitable metric operable to measure the performance of a model when performing its task(s). In some embodiments of the invention, the performance metric is the model accuracy (or modeling accuracy) of the model. Model accuracy is defined as the number of tasks or determinations a model performs correctly divided by the total number of tasks or determinations performed. In aspects of the invention, the ML model can be configured to apply confidence levels (CLs) to its tasks/determinations in order to improve the overall accuracy of the task/determination. When the ML model performs a task or makes a determination for which the value of CL is below a predetermined threshold (TH) (i.e., CL<TH), the task/determination can be classified as having sufficiently low “confidence” to justify a conclusion that the task/determination is not valid. If CL>TH, the task/determination can be considered valid. Many different predetermined TH levels can be provided such that the tasks/determinations with CL>TH can be ranked from the highest CL>TH to the lowest CL>TH, which can further assist in evaluating the similarity or dissimilarity of the modeling accuracy results generated by the different local ML models.

In some embodiments of the invention, the performance metric is the mean absolute percent error, which is calculated by taking the mean of the absolute value of the actual values minus the predictions divided by the actual values. In some embodiments of the invention, the performance metric is the receiver operating characteristic (ROC) curve. The ROC curve is created by plotting the true positive rate of the model against the false positive rate at various threshold settings. An assessment of model performance can be made based on this curve, where models that achieve a high AUC (area under the curve) are favored.

In accordance with aspects of the invention, the results of the benefit analysis applied to the performance metrics serve as a proxy for whether Party A's local training data are sufficiently different from Party B's local training data, or whether Party A's local training data are sufficiently complementary to Party B's local training data, that a common ML model generated through federated learning between Party A and Party B will have meaningfully better performance than the non-federated local Party A or Party B ML model operating alone. For example, if the local performance metric(s) and the remote performance metric(s) are close to one another (e.g., the performance metrics are within a predetermined range of values of each other), Party A's local ML model performs substantially as well on Party A's local training/test data as on Party B's local training/test data, which supports an inference or conclusion that Party A's local training data and Party B's local training data are sufficiently similar that there is little benefit from training Party A's local ML model and Party B's local ML model in a federated learning system. Similarly, if the local performance metric(s) and the remote performance metric(s) are not very close (e.g., the separation between local performance metric(s) and the remote performance metric(s) is greater than a predetermined range of values), Party A's local ML model performs differently on Party A's local training/test data than it performs on Party B's local training/test data, which supports an inference or conclusion that Party A's local training data and Party B's local data are sufficiently dissimilar that there would be a benefit from training Party A's local ML model and Party B's local ML model in a federated learning system.

In accordance with aspects of the invention, in addition to identifying an overall benefit to Party A and Party B participating in a federated learning system, the results of the benefit-analysis can include computations on the performance metrics that identify whether or not Party A and Party B would benefit equally from participating in the same federated learning system. For example, the results of the benefit-analysis could include computations that identify that about 30% of the federated model improvements would be experienced by Party A, while about 70% of the federated model improvements would be experienced by Party B. In accordance with aspects of the invention, these computations can be used to equitably apportion the cost of setting up and maintaining a federated learning system among the federation members based on the benefits that flow to each member, as well as convincing a candidate to join the federation.

In embodiments of the invention, the confidentially of Party A's local ML model is maintained by providing a trusted execution environment (TEE) at Party B; using secure communications channels to transmit Party A's local ML model to the TEE of Party B; and performing all of the evaluations of Party A's local ML model that take place at Party B within the TEE. Similarly, in embodiments of the invention, the confidentially of Party B's local ML model is maintained by providing a TEE at Party A; using secure communications channels to transmit Party B's local ML model to the TEE of Party A; and performing all of the evaluations of Party B's local ML model that take place at Party B within the TEE. In general, a TEE is an area on the main processor of a device that is separated from the system's main operating system (OS). A TEE ensures that data is stored, processed, and protected in a secure environment. TEEs provide protection for any connected “thing,” such as a trusted application (TA), by enabling an isolated, cryptographic electronic structure and enable end-to-end security. This includes the execution of authenticated code, confidentiality, authenticity, privacy, system integrity, and data access rights. The evaluations of Party A's local ML model that take place at Party B are controlled by an instance of benefit-analysis “matchmaking” code that is also transmitted to the TEE using the secure communications channels. Similarly, the evaluations of Party B's local ML model that take place at Party A are controlled by an instance of “matchmaking” code that is also transmitted to the TEE using the secure communications channels. When the evaluations of Party A's local ML model that take place at Party B are completed, the matchmaker code and Party A's local ML model are securely deleted from the TEE resident at Party B. When the evaluations of Party B's local ML model that take place at Party A are completed, the matchmaker code and Party B's local ML model are securely deleted from the TEE resident at Party A.

Accordingly, embodiments of the invention improve both the security and reliability of exchanges that take place between Party A and Party B when performing the novel benefit-analysis matchmaking operations. The use of secure communications channels and TEEs prevent Party A or Party B from reverse engineering the other party's model to derive the confidential local data was used to train the other party's model. The use of secure communication channels and TEEs to compute the benefits of federation membership improves reliability of these computations because a federation candidate cannot inflate or deflate its actual performance metric computations, which some candidates may desire to do. For example, as previously noted, the cost of setting up and maintaining a federation can be apportioned among the federation members based on the benefits (e.g., improved modeling accuracy) that flow to each federation member. A first proposed federation member who computes the benefits it derives from using a second proposed federation member's local model could be motivated to understate the computed benefit to reduce the first proposed federation member's share of the costs to set up and maintain the federation. In accordance with aspects of the invention, the use of secure communication channels and TEEs to securely compute the benefits of federation membership prevents any party from interfering with the computations, thereby preserving the integrity of the computations and the federated learning process.

In some embodiments of the invention, a cloud computing server can be used to perform the novel benefit-analysis matchmaking operations by providing secure communications channels between each candidate and the cloud computing server; providing a TEE at the server; transmitting the local test data sets, benefit-analysis matchmaker code, and the local ML models over the secure communications channel to the TEE; performing novel benefit-analysis matchmaking operations at the TEE; and securely deleting the benefit-analysis matchmaker code, the local test data sets, and the local ML models from the TEE subsequent to the novel benefit-analysis matchmaking operations being completed.

For ease of illustration and explanation, the above-described example uses two candidates, Party A and Party B. However, embodiments of the invention described herein can be applied to any number of candidates, where each candidate securely and reliably evaluates the performance of its local ML model on its own local test data and on the local test data at each of the other candidates. Where more than two candidates are evaluated using aspects of the invention, the performance metrics of each local ML model can be organized in a table or matrix; candidates having similar local test data can be clustered; and the efficiency of the federated learning system can be improved by matching candidates that are not within the same cluster. In some embodiments of the invention, a ML model can be used to perform the task of identifying the clusters and selecting well-matched candidates that are not within the same cluster. The clustering tasks can include determining the similarity between model performance metrics by applying similarity techniques and (optionally) the previously-described CLs to determine a numerical representation of the similarity between the various model performance metrics in the table or matrix. In some embodiments of the invention, the similarity techniques can include establishing a threshold for the separation between performance metrics that will be considered similar to one another.

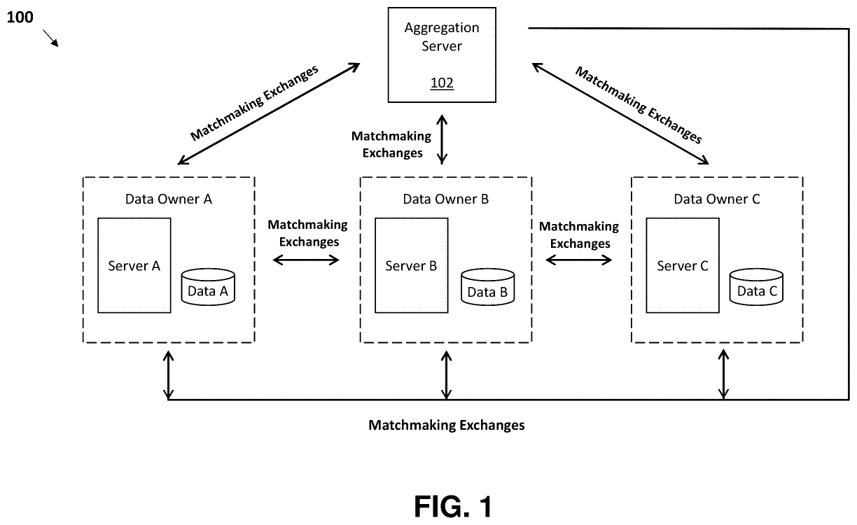

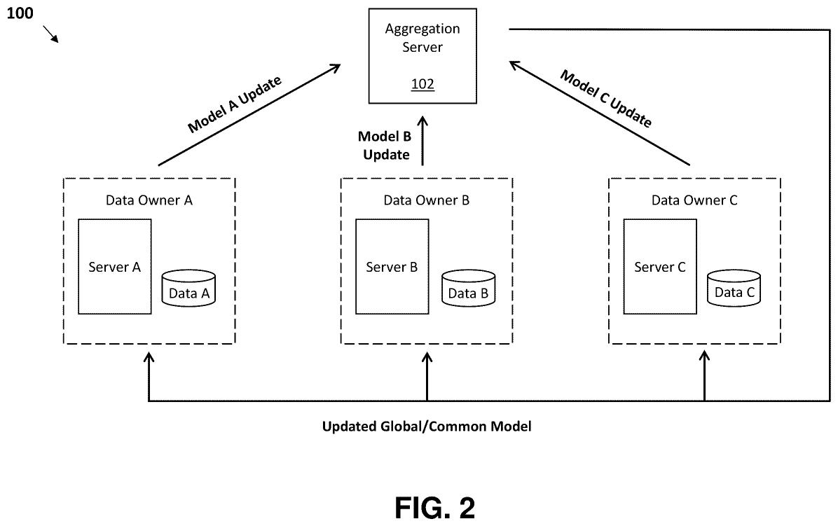

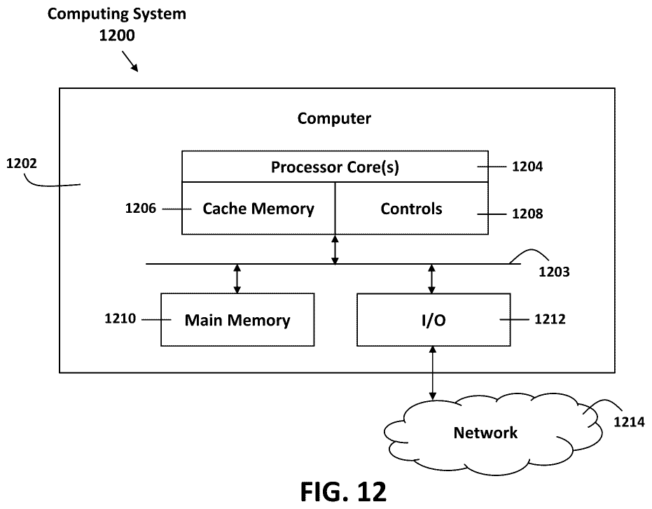

Turning now to a more detailed description of aspects of the invention, FIG. 1 depicts a simplified block diagram illustrating a federated learning system 100 having secure and reliable benefit-analysis matchmaking in accordance with embodiments of the invention. FIG. 2 depicts a simplified block diagram of the federated learning system 100 operable to implement federated learning in accordance with embodiments of the invention after completion of the secure and reliable benefit-analysis matchmaking operations depicted in FIG. 1. The federated learning system 100 can be implemented in conjunction with any appropriate computing device and database, such as computer system 1200 of FIG. 12. The federated learning system 100 includes an aggregation server 102 and Data Owners A-C, configured and arranged as shown. Each of the Data Owners A-C has a respective Server A-C and local datasets shown a Data A-C. Data A-C can be stored in its associate server (Servers A-C) or in a separate database.

The block diagram of the federated learning system 100 shown in FIGS. 1 and 2 is simplified in that it is not intended to indicate that the system 100 is to include all of the components shown. Instead, the federated learning system 100 can include any appropriate fewer or additional components not illustrated in FIGS. 1 and 2 (e.g., aggregation servers, data owners, local servers, local datasets, additional memory components, embedded controllers, functional blocks, connections between functional blocks, modules, inputs, outputs, etc.). Further, the embodiments of the invention described herein with respect to the federated learning system 100 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

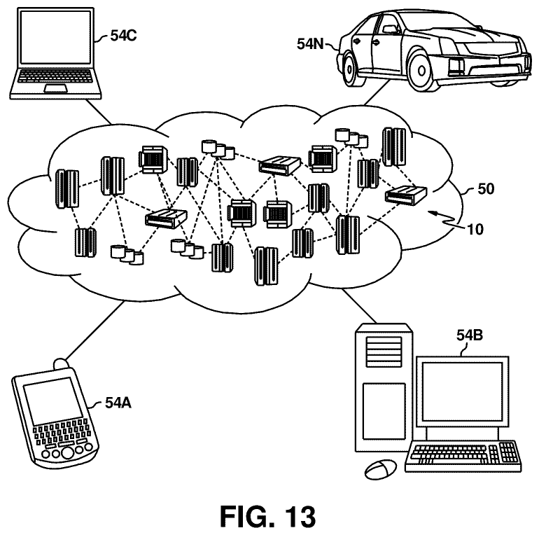

A cloud computing system 50 (shown in FIG. 13) can be in wired or wireless electronic communication with one or all of components of the system 100. Cloud computing system 50 can supplement, support, or replace some or all of the functionality of the components of the system 100. Additionally, some or all of the functionality of the components of the system 100 can be implemented as a node 10 (shown in FIG. 13) of cloud computing system 50.

Referring now to FIG. 1, the federated learning system 100 includes an aggregation server 102 communicatively coupled to servers and data repositories for various data owners. Data Owner A maintains Server A and Data A (or data repository A); Data Owner B maintains Server B and Data B (or data repository B); and Data Owner C maintains Server C and Data C (or data repository C). In some embodiments of the invention, the Data Owners A-C are entities that operate in the same general field (e.g., hospital healthcare) but are each a separate entity at a separate physical location. For example, Data Owner A can be a general acute care hospital in a suburb of City A; Data Owner B can be a long-term care hospital within the city limits of City A; and Data Owner C can be a government hospital (e.g., a Veteran's Health Administration (VHA) hospital) within the city limits of City A. Each of the Servers A-C can include sub-components such as multiple individual processors, processor systems, or servers, all in communication with one another at their particular location (e.g., the sub-components of Server A are at Data Owner A's physical location).

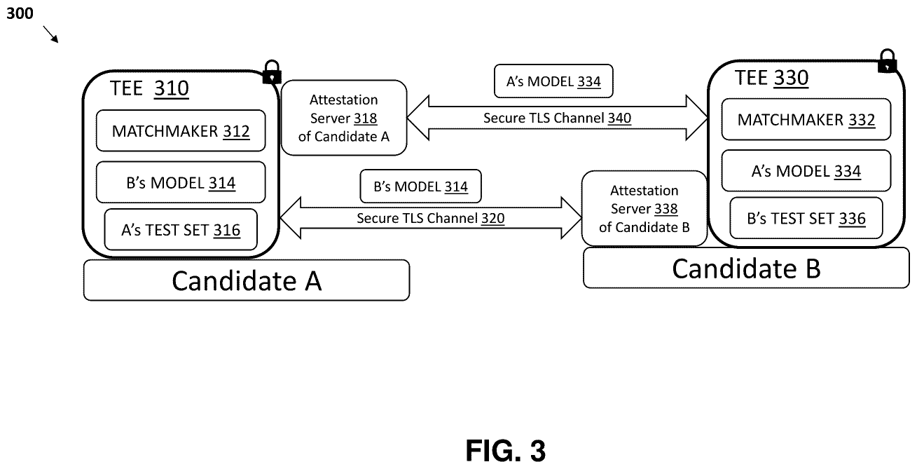

The Data Owners A-C have been selected for participation in the federated learning system 100 using secure and reliable benefit-analysis matchmaking in accordance with embodiments of the invention. As a non-limiting example, assume that a diagnostic device manufacturer has developed a new Diagnostic System A, which uses machine learning algorithms to generate a disease-state detection model operable to perform the task of detecting on X-rays potential disease states that are difficult to detect using the human eye. The diagnostic device manufacturer has identified that each of the Data Owners A-C could use Diagnostic System A, and has further identified, through use of secure and reliable benefit-analysis matchmaking exchanges in accordance with embodiments of the invention, that a common disease-state detection ML model trained using the federated learning system 100 would have meaningfully better modeling accuracy than a local disease-state detection ML model generated for each of the Data Owners A-C using each respective data owner's local data (e.g., Data A alone, Data B alone, or Data C alone). Examples of how secure and reliable benefit-analysis matchmaking exchanges in accordance with embodiments of the invention can be implemented are depicted in FIGS. 3-11 and described in detail subsequently herein.

Referring now to FIG. 2, the federated learning system 100 is depicted after the Data Owners A-C have been selected using secure and reliable benefit-analysis matchmaking in accordance with embodiments of the invention as shown in FIG. 1. The federated learning system 100 can implement any type of federated learning. In general, federated learning is a process of computing a common or global ML model by using input from several locally resident ML models that have been trained using private and locally held data. In some embodiments of the invention, the federated learning process implemented by the federated learning system 100 includes the aggregation server 102 generating an initial version of a global or common ML model and broadcasting it to each of the Servers A-C. Each of the Servers A-C, includes training data and test data. Each of the Servers A-C uses its local data to train its own local ML model in a privacy-preserving way (to avoid leakage of sensitive inferences about its data) and sends parameters of its local ML model to the aggregation server 102, which collects the parameters of the various ML models from the Servers A-C, uses them to calculate updated parameters for the global ML model, and sends the global ML model parameters back to the Servers A-C for a new round of local ML model training based on the global ML model parameters. After several rounds of continuously updating the global ML model in this fashion, a desired model performance level is reached. The aggregation server 102 then shares this global ML model with each of the Servers A-C for (future) use on each of the Server's private and locally held data.

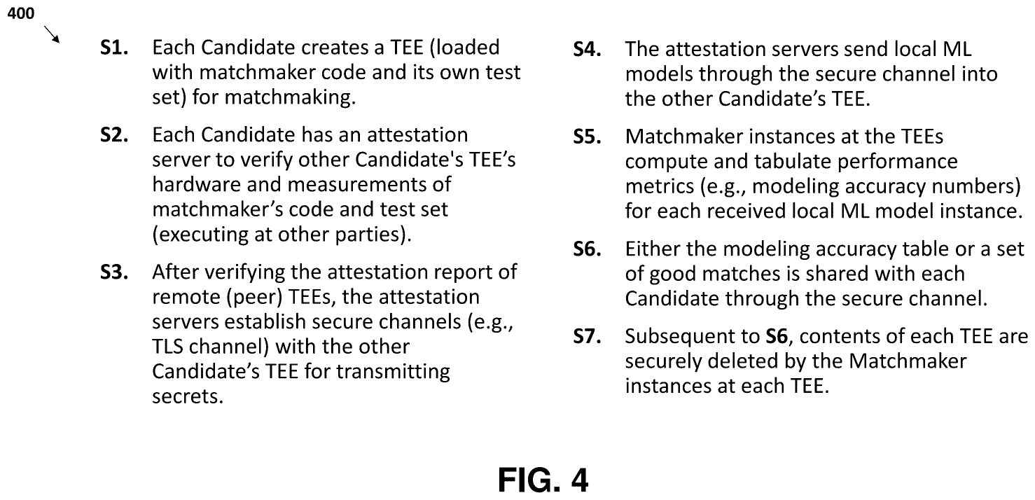

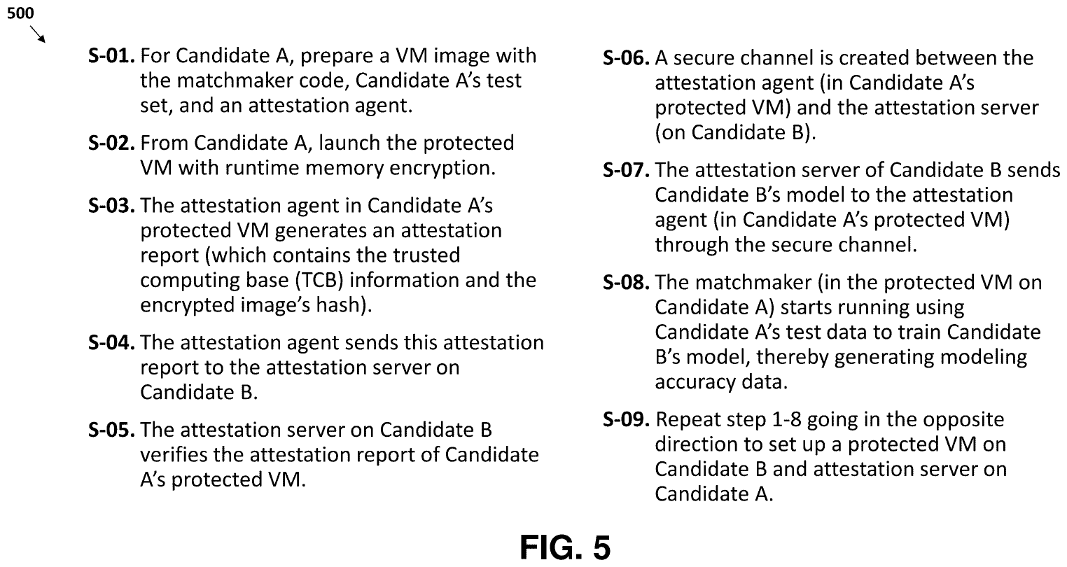

FIG. 3 depicts a simplified block diagram illustrating a candidate evaluation system 300 having secure and reliable benefit-analysis matchmaking in accordance with embodiments of the invention. FIG. 4 depicts a flow diagram illustrating a computer-implemented methodology 400 that is implemented by the system 300 in accordance with embodiments of the invention. FIG. 5 depicts a flow diagram illustrating a computer-implemented methodology 500 that is implemented by the system 300 in accordance with embodiments of the invention. The operation of system 300 shown in FIG. 3 will be described with reference to the system 300 shown in FIG. 3; the methodology 400 shown in FIG. 4 that is implemented by the system 300; and the methodology 500 shown in FIG. 5 that is implemented by the system 300. For ease of illustration and explanation, the system 300 depicts interactions between two federated learning candidates, Candidate A and Candidate B. However, it is understood that any number of federated learning candidates can be evaluated, where each candidate evaluates its own local test data on its own local ML model and on the local ML models of the other candidates.

As shown in FIG. 3, the system 300 is operable to implement a benefit-analysis matchmaking operation between Candidate A and Candidate B in accordance with aspects of the invention. For example, Candidate A corresponds to Data Owner A (Server A and Data A shown in FIG. 1) before initiation of the federated learning operations depicted in FIG. 2. Similarly, Candidate B corresponds to Data Owner B (Server B and Data B shown in FIG. 1) before initiation of the federated learning operations depicted in FIG. 2. The system 300 includes a TEE 310 located at a server of Candidate A (e.g., Server A and Data A shown in FIG. 1) and a TEE 330 located at a server of Candidate B (e.g., Server B and Data B shown in FIG. 1), where each Candidate A and B creates its own TEE, 310, 330 (S1). A suitable technology for implementing the TEEs 310, 330 is commercially available from Advanced Micro Devices (AMD®) and identified by the trade name Secure Encrypted Virtualization (SEV). TEE 310 is loaded with matchmaker code 312 and a copy of Candidate A's test set 316, and TEE 330 is loaded with matchmaker code 332 and a copy of Candidate B's test set 336. At this stage, Candidate A's local ML model 334 has been trained at Candidate A using Candidate A's training set data, and Candidate B's local ML model 314 has been trained at Candidate B using Candidate B's training set data. Additionally, performance metrics (e.g., modeling accuracy) from each Candidate's trained local ML model 314, 334 on its own local test set 316, 336 are computed and tabulated. Candidate A includes an attestation server 318 (S2), and Candidate B includes an attestation server 338 (S2). Each attestation server 318, 338 verifies the other Candidate's TEE hardware, operating system, software stack, and measurements generated by the by the matchmaker code 312, 332. After the verification, attestation server 318 establishes a secure communications channel 340 between the attestation server 318 and the TEE 330 for transmitting secrets (S3). Similarly, after the verification, attestation server 338 establishes a secure communications channel 320 between the attestation server 338 and the TEE 310 for transmitting secrets (S3).

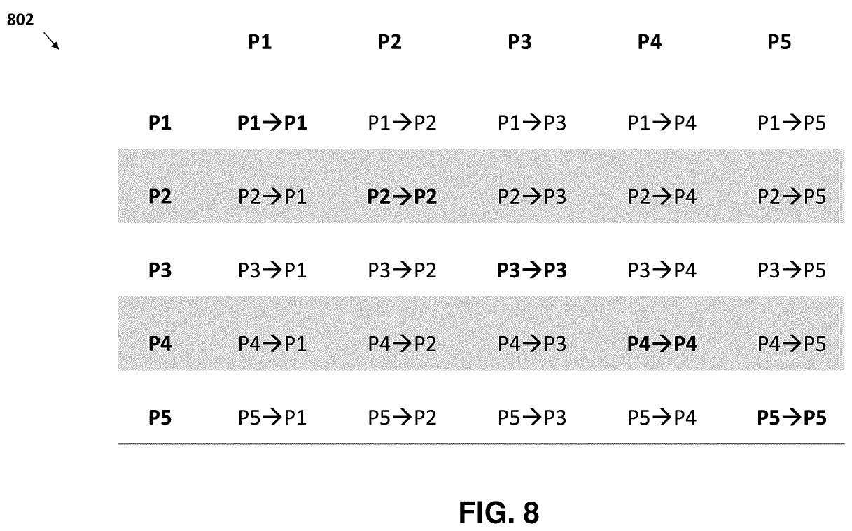

The attestation server 318 sends Candidate A's local ML model 334 through the secure channel 340 into the TEE 330 (S4), and the attestation server 338 sends Candidate B's local ML model 314 through the secure channel 320 into the TEE 310 (S4). The matchmaker code 312 at the TEE 310 computes and tabulates performance metrics (e.g., modeling accuracy numbers) of the received Candidate B local ML model 314 using Candidate A's test data 316 (S4, S5). Similarly, the matchmaker code 332 at the TEE 330 computes and tabulates performance metrics (e.g., modeling accuracy numbers) of the received Candidate A local ML model 334 using Candidate B's test data 336 (S4, S5). In accordance with aspects of the invention, the matchmaker codes 312, 332 also perform benefit-analysis matchmaking operations on all of the computed performance metrics. The matchmaker codes 312, 332 can coordinate with each other over the secure communications channels 320, 340 to organize the performance metrics of each local ML model in a table or matrix; cluster candidates having similar local test data; match candidates that are not within the same cluster; and, optionally, share the resulting matches and/or the tables over the secured communications channels 320, 340 with the Candidates A, B (outside of the TEEs 310, 330) (S6). Additional details of the benefit-analysis matchmaking operations performed by the matchmaker codes 312, 332 are depicted in FIGS. 8-11 and described in greater detail subsequently herein.

In some embodiments of the invention, a ML model can be used to perform the task of identifying the clusters and selecting well-matched candidates that are not within the same cluster. The clustering tasks can include determining the similarity between model performance metrics by applying similarity techniques and (optionally) the previously-described CLs to determine a numerical representation of the similarity between the various model performance metrics in the table or matrix. In some embodiments of the invention, the similarity techniques can include establishing a threshold for the separation between performance metrics that will be considered similar to one another.

In some embodiments of the invention, the benefit-analysis matchmaker code 312, 332, the local test data sets 316, 336, and the local ML models 314, 334, are securely deleted from the TEEs 310, 330 when the novel benefit-analysis matchmaking operations performed by the matchmaker codes 312, 332 are completed.

FIG. 5 depicts a flow diagram illustrating a computer-implemented methodology 500 that is implemented by the system 300 (shown in FIG. 3) in accordance with embodiments of the invention to automate S1 of the methodology 400 (shown in FIG. 4) in which each Candidate A and B sets up its own TEE 310, 330. At S-01 (Step 01), Candidate A (e.g., using Server A shown in FIG. 1) prepares a virtual machine (VM) image with the matchmaker code 312, Candidate A's test set 316, and an attestation agent. At S-02 (Step 02), Candidate A (e.g., using Server A shown in FIG. 1) launches the protected VM with runtime memory encryption. At S-03 (Step 03), the attestation agent in Candidate A's protected VM generates an attestation report (which contains the trusted computing base (TCB) information and the encrypted image's hash). At S-04 (Step 04), the attestation agent sends this attestation report to the attestation server 338 on Candidate B. At S-05 (Step 05), the attestation server 338 on Candidate B verifies the attestation report of Candidate A's protected VM. At S-06 (Step 06), a secure channel 320 is created between the attestation agent (in Party A's protected VM) and the attestation server 338 (on Candidate B). At S-07 (Step 07), the attestation server 338 of Candidate B sends Candidate B's model 314 to the attestation agent (in Party A's protected VM) through the secure channel 320. At S-08 (Step 08), the matchmaker (in the protected VM on Candidate A) starts running with Candidate A's test set 316 training Candidate B's model 314. At S-09 (Step 09), S-01 through S-08 are repeated with the roles reversed in order to set up a protected VM on Candidate B and attestation server 318 on Candidate A.

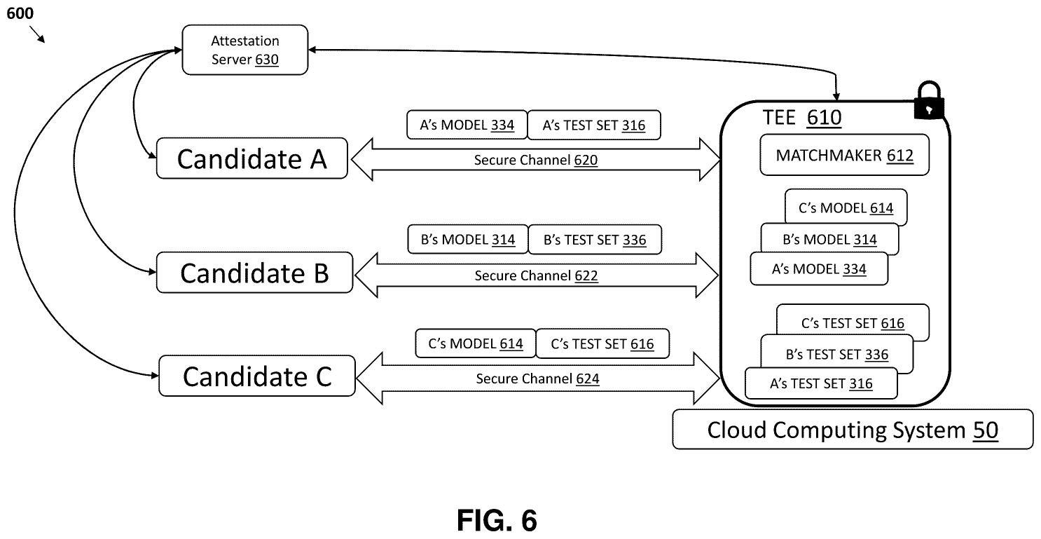

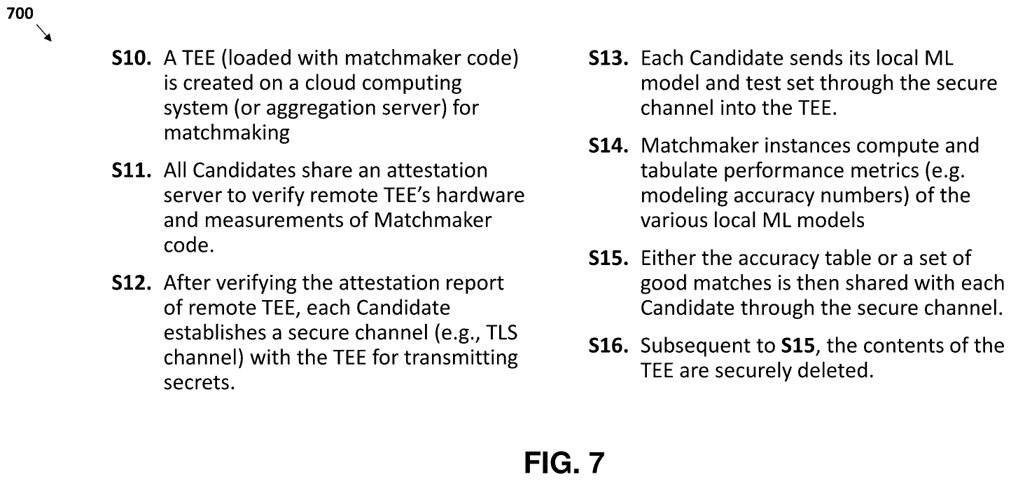

FIG. 6 depicts a simplified block diagram illustrating a candidate evaluation system 600 having secure and reliable benefit-analysis matchmaking in accordance with embodiments of the invention. FIG. 7 depicts a flow diagram illustrating a computer-implemented methodology 700 that is implemented by the system 600 in accordance with embodiments of the invention. The operation of system 600 shown in FIG. 6 will be described with reference to the system 600 shown in FIG. 6; and the methodology 700 shown in FIG. 7 that is implemented by the system 600. For ease of illustration and explanation, the system 600 depicts the interaction between three federated learning candidates, Candidate A, Candidate B, and Candidate C. However, it is understood that any number of federated learning candidates can be evaluated, where each candidate evaluates its own local test data on its own local ML model and on the local ML models of all of the other candidates.

As shown in FIG. 6, the system 600 is operable to implement benefit-analysis matchmaking operations on Candidate A, Candidate B, and Candidate C. For example, Candidate A corresponds to Data Owner A (Server A and Data A shown in FIG. 1) before initiation of the federated learning operations depicted in FIG. 2. Similarly, Candidate B corresponds to Data Owner B (Server B and Data B shown in FIG. 1) before initiation of the federated learning operations depicted in FIG. 2. Similarly, Candidate C corresponds to Data Owner C (Server C and Data C shown in FIG. 1) before initiation of the federated learning operations depicted in FIG. 2. The system 600 is centralized in that the matchmaking analyses are performed at a central location, which can be the cloud computing system 50 or the aggregation server 102 (shown in FIG. 1).

The system 600 includes a centralized TEE 610, which is created (S10) at a server of a cloud computing system 50. A suitable technology for implementing the TEE 610 is commercially available from Advanced Micro Devices (AMD®) and identified by the trade name Secure Encrypted Virtualization (SEV). TEE 610 is loaded with matchmaker code 612. At this stage, Candidate A's local ML model 334 has been trained at Candidate A using Candidate A's training data; Candidate B's local ML model 314 has been trained at Candidate B using Candidate B's training data; and Candidate C's local ML model 614 has been trained at Candidate C using Candidate C's training data. Candidates A-C share an attestation server 630 (S11). The attestation server 630 verifies the attestation report of TEE 610 (S12). After the verification, attestation server 630 establishes secure communications channels 620, 622, 624 between the Candidates A-C and the TEE 610 for transmitting secrets (S12).

Each of the Candidates A-C sends its local ML model 334, 314, 614 and test set 316, 336, 616 through the secure channels 620, 622, 624, respectively, and into the TEE 610 (S13). The matchmaker code 612 at the TEE 610 computes and tabulates performance metrics (e.g., modeling accuracy numbers) of the received Candidate A local ML model 334 using Candidate B's test data 336 (S14). Similarly, the matchmaker code 612 at the TEE 610 computes and tabulates performance metrics (e.g., modeling accuracy numbers) of the received Candidate A local ML model 334 using Candidate C's test data 616 (S14). The matchmaker code 612 at the TEE 610 further computes and tabulates performance metrics (e.g., modeling accuracy numbers) of the received Candidate B local ML model 314 using Candidate A's test data 316 (S14). Similarly, the matchmaker code 612 at the TEE 610 computes and tabulates performance metrics (e.g., modeling accuracy numbers) of the received Candidate B local ML model 314 using Candidate C's test data 616 (S14). The matchmaker code 612 at the TEE 610 computes and tabulates performance metrics (e.g., modeling accuracy numbers) of the received Candidate C local ML model 614 using Candidate A's test data 316 (S14). Similarly, the matchmaker code 612 at the TEE 610 computes and tabulates performance metrics (e.g., modeling accuracy numbers) of the received Candidate C local ML model 614 using Candidate B's test data 336 (S14).

In accordance with aspects of the invention, the matchmaker code 612 also performs benefit-analysis matchmaking operations on the computed performance metrics. The matchmaker code 612 is operable to organize the performance metrics of each local ML model in a table or matrix; cluster candidates having similar local data; match candidates that are not within the same cluster; and share the tables over the secured communications channels 620, 622, 624 with the Candidates A-C (outside of the TEE 610) (S15). Additional details of the benefit-analysis matchmaking operations performed by the matchmaker codes 610 are depicted in FIGS. 8-11 and described in greater detail subsequently herein.

In some embodiments of the invention, a ML model can be used to perform the task of identifying the clusters and selecting well-matched candidates that are not within the same cluster. The clustering tasks can include determining the similarity between model performance metrics by applying similarity techniques and (optionally) the previously-described CLs to determine a numerical representation of the similarity between the various model performance metrics in the table or matrix. In some embodiments of the invention, the similarity techniques can include establishing a threshold for the separation between performance metrics that will be considered similar to one another.

In some embodiments of the invention, the benefit-analysis matchmaker code 612, the local test data sets 316, 336, 616 and the local ML models 314, 334, 614 are securely deleted from the TEE 610 when the novel benefit-analysis matchmaking operations performed by the matchmaker code 612 are completed.

FIG. 8 illustrates a comparison table/matrix 802 that can be generated by the systems 100, 300, 600 and used to compare performance metrics of local models for the purpose of evaluating whether and how much each candidate party (P) of the federation would benefit from federated learning. In the illustrated example, the performance metric is modeling accuracy, although other performance metrics can be used. Also in the illustrated example, there are five parties (P), which are shown as P1 through P5, although any number of parties can be used. Each column of the table/matrix 802 is associated one of the parties, and each row of the table/matrix is associated with one of the parties. In general, when training a ML model, data is partitioned uniformly into a training set and a test set. Each of P1-P5 trains a local model on its local data “training set” and computes a modeling accuracy of its trained local ML model on its local data “test set.” For each party, the modeling accuracy that results from locally training the party's local model is plotted on the table/matrix 802 at the intersection of the party's row and the same party's corresponding column (e.g., P1→P1, P2→P2, P3→P3, P4→P4, P5→P5). Each of P1-P5 then uses its own local test set data to compute performance metrics of each of the other parties' local ML models. For example, the P1 local ML model is provided to P2, P2 computes a performance metric of the P1 local ML model using P2's local test data, and the computed performance metric is entered on the table/matrix 802 as P1→P2. This process is repeated for P3-P5, which results in the remaining entries (P1→P3, P1→P4, P1→P5) shown across the first row of the table/matrix 802. The corresponding modeling accuracy computations for the remaining rows of the table/matrix 802 are completed and entered. When the table/matrix 802 is completed, the various modeling accuracies can be analyzed (e.g., clustered and compared) to determine whether and how much each party P would benefit from being collaboratively trained with the other parties through a federated learning system (e.g., federated learning system 100).

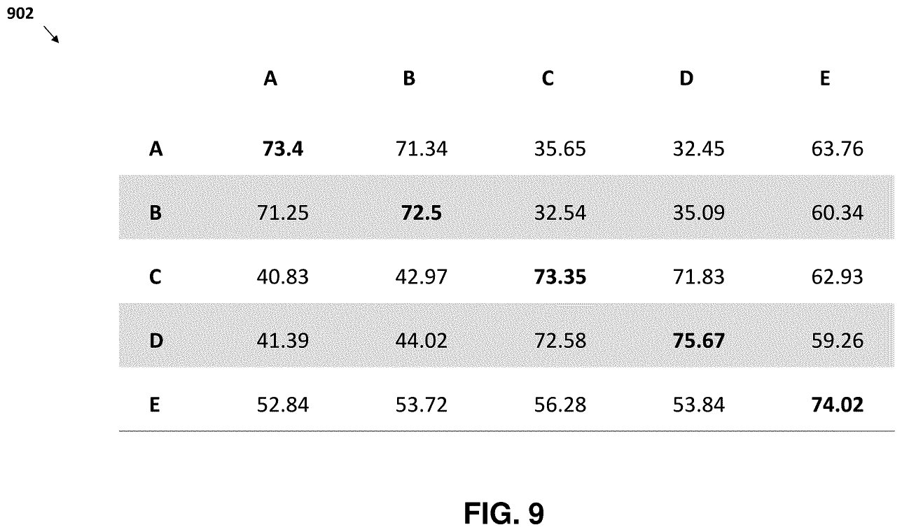

FIG. 9 illustrates a comparison table/matrix 902 that corresponds to the comparison matrix/table 802 (shown in FIG. 8) but provides actual modeling accuracy examples based on the CIFAR-10 dataset, which includes 60,000 32×32 color images in classes, with 6000 images per class. The CIFAR-10 dataset includes 50000 training images and 10000 test images. For the example depicted in FIG. 9, the CIFAR-10 dataset is divided into five training batches and one test batch, each with 10000 images. The CIFAR-10 has data split over 10 labels in Non-IID (identically and independently distributed) form. For the depicted examples, the CIFAR-10 was divided among five (5) parties—Party A, Party B, Party C, Party D, and Party E. Party E received a uniform distribution among all 10 labels. Parties A and B each received 90% of its data items from the first five labels (L1-L5), and received 10% of its data items from the other labels. Accordingly, Parties A and B have similar data. Parties C and D each received 90% data of its items from the next five labels (L6-L10), and received 10% of its data items from the other labels. Accordingly, Parties C and D have similar data. Additionally, with the above-described data distribution, Party E has data that is dissimilar from Parties A, B, C, and D.

Similar to the table/matrix 802 (shown in FIG. 8), each column of the table/matrix 902 is associated with one of the parties, and each row of the table/matrix 902 is associated with one of the parties. In general, when training a ML model, data is partitioned uniformly into a training set and a test set. Each of Party A through Party E evaluates a local model on its local data “test set” and computes a modeling accuracy of its trained local ML model. For each party, the modeling accuracy that results from locally training the party's local model is plotted on the table/matrix 902 at the intersection of the party's row and the same party's corresponding column (e.g., 73.4, 72.5, 73.35, 75.67, and 74.02). Each of Party A through Party E also uses its own local test set data to computer performance metrics of each of the other parties' local ML models. For example, the Party A local ML model is provided to Party B, Party B computes a performance metric of the Party A local ML model using Party B's local test data, and the computed performance metric is entered on the table/matrix 902 as 71.34. This process is repeated for Party C through Party E, which results in the remaining entries (35.65, 32.45, and 63.76) shown across the first row of the table/matrix 902. The corresponding modeling accuracy computations for the remaining rows of the table/matrix 902 are completed and entered. When the table/matrix 902 is completed, the various modeling accuracies can be analyzed (e.g., clustered and compared) to determine whether and how much each of the parties would benefit from being collaboratively trained through the federated learning system 100 (shown in FIG. 2).

Embodiments of the invention create and analyze the table/matrix 902 to make selected observations about the modeling accuracy values (similarities and differences) in the table/matrix 902. In some embodiments of the invention, the table/matrix 902 is created and analyzed using the various instances of benefit-analysis matchmaker code 312, 332, 612 (shown in FIGS. 3 and 6). The first row of the table/matrix 902 shows how well Party A's local ML model performs on the local test data from Parties A-E, respectively. As shown in the first row, Party A's local ML model performs substantially as well (73.4) on its own local test data as it performs (71.34) on Party B's local test data. As also shown in the first row, Party A's local ML model does not perform very well (35.65) on Party C's local test data, Party D's local test data (32.45), or Party E's local test data (63.75).

The second row of the table/matrix 902 shows how well Party B's local ML model performs on the local test data from Parties A-E, respectively. As shown in the second row, Party B's local ML model performs substantially as well (71.25) on Party A's local test data as it performs (72.5) on Party B's local test data. As also shown in the second row, Party B's local ML model does not perform very well (32.54) on Party C's local test data, Party D's local test data (35.09), or Party E's local test data (60.34).

The third row of the table/matrix 902 shows how well Party C's local ML model performs on the local test data from Parties A-E, respectively. As shown in the third row, Party C's local ML model does not perform very well (40.83) on Party A's local test data and does not perform very well (42.97) on Party B's local test data. As also shown in the third row, Party C's local ML model performs substantially as well (73.25) on Party C's local test data as it performs (71.83) on Party D's local test data. As also shown in the third row, Party C's local ML model does not perform very well (62.93) on Party E's local test data.

The fourth row of the table/matrix 902 shows how well Party D's local ML model performs on the local test data from Parties A-E, respectively. As shown in the fourth row, Party D's local ML model does not perform very well (41.39) on Party A's local test data and does not perform very well (44.02) on Party B's local test data. As also shown in the fourth row, Party D's local ML model performs substantially as well (72.58) on Party C's local test data as it performs (75.67) on Party D's local test data. As also shown in the fourth row, Party D's local ML model does not perform very well (59.26) on Party E's local test data.

The fifth row of the table/matrix 902 shows how well Party E's local ML model performs on the local test data from Parties A-E, respectively. As shown in the fifth row, Party E's local ML model does not perform very well (52.84) on Party A's local test data, does not perform very well (53.72) on Party B's local test data, does not perform very well (56.28) on Party C's local test data, and does not perform very well (53.84) on Party D's local test data. As also shown in the fifth row, Party E's local ML model performs well (74.02) on Party E's local test data.

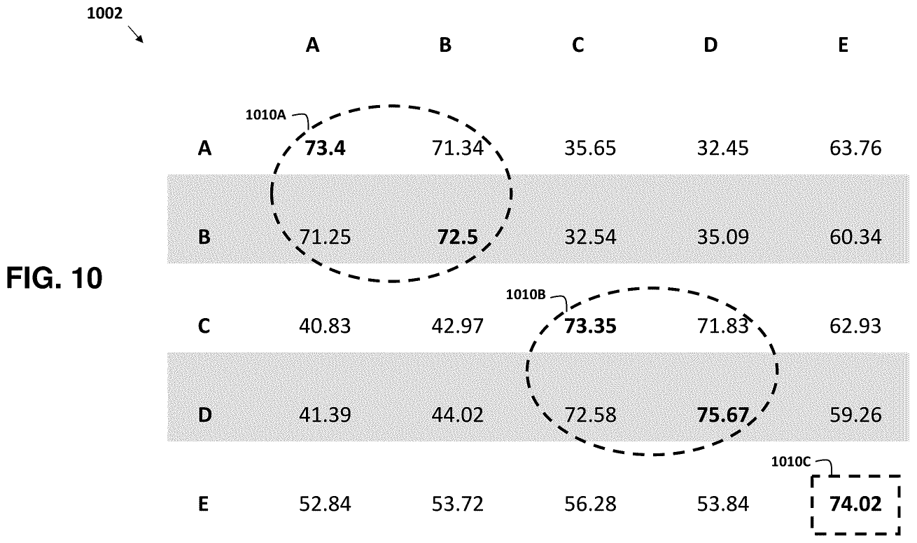

FIG. 10 illustrates a comparison table/matrix 1002 that corresponds to the comparison matrix/table 902 (shown in FIG. 9) but provides an identification (e.g., using the matchmaker code 310, 330, 610 shown in FIGS. 3 and 6) of cluster regions 1010A, 1010B, 1010C that have substantially similar computed modeling accuracies. Embodiments of the invention draw inferences (e.g., using the matchmaker code 310, 330, 610 shown in FIGS. 3 and 6) from the observation that cluster regions 1010A, 1010B, 1010C have substantially similar computed modeling accuracies, including the inference that there is little benefit from training a federated learning system constructed solely from a combination drawn from the Parties that fall within the cluster regions 1010A, 1010B, 1010C.

Embodiments of the invention can draw further inferences about the result of federating parties using the table/matrix 802/1002 without actually federating the parties. As an example, if modeling accuracy P2→P4 in table/matrix 802 is lower than modeling accuracy P4→P2, it implies that P4's model performs better on P2's data than P2's model on P4's data. It can therefore be inferred that in a federated learning system with P2 and P4, P2 benefits more. Computing and evaluating peak modeling accuracy that results from federating various groups of the Parties A-E can be used in embodiments of the invention to validate the inferences, including, for example, that combining Party D with Party B in a federated learning system would result in a peak modeling accuracy of 89.1, which is an improvement over Party B's local ML model performance on Party B's local test set (72.5), and which is also an improvement over Party D's local ML model performance on Party D's local test set (75.67). Additionally, computing and evaluating peak modeling accuracy results in uncovering that Party B will benefit more (89.1−72.5=16.6) from being trained with Party D than Party D will benefit from being trained with Party B (89.1−75.67=13.43). Embodiments of this invention can uses the inferences described above (e.g., using the matchmaker code 310, 330, 610 shown in FIGS. 3 and 6) to predict this without actually executing the federated learning process just by examining modeling accuracy B→D (35.09) and D→B (44.02).

Combining Party D with Party B in a federated learning system would result in a peak modeling accuracy of 89.1, which is an improvement over Party A's local ML model performance on Party A's local test set (73.4), and which is also an improvement over Party D's local ML model performance on Party D's local test set (75.67).

Referring still to FIG. 10, as another example, computing and evaluating peak modeling accuracy results in uncovering that combining Party D with a combination of Party A, Party B, and Party C (e.g., D+(A+B+C)) in a federated learning system would result in a peak modeling accuracy of 89.7, which is an improvement over Party A's local ML model trained on Party A's local test set (73.4); an improvement over Party B's local ML model trained on Party B's local test set (72.5); an improvement over Party C's local ML model trained on Party C's local test set (73.35); and an improvement over Party D's local ML model trained on Party D's local test set (75.67). Additionally, computing and evaluating peak modeling accuracy results in uncovering the expected benefit (e.g., modeling accuracy increase) for each of Party A-D using the same method used to determine the benefits that accrue to each Party in the federated learning combination of Party D with Party B.

Referring still to FIG. 10, as another example, computing and evaluating peak modeling accuracy results in uncovering that combining Party D with Party A in a federated learning system would result in a peak modeling accuracy of 88.5, which is an improvement over Party A's local ML model trained on Party A's local test set (73.4), and which is also an improvement over Party D's local ML model trained on Party D's local test set (75.67). Additionally, computing and evaluating peak modeling accuracy results in uncovering that Party A will benefit more (88.5−73.4=15.1) from being trained with Party D than Party D will benefit from being trained with Party A (88.5−75.67=12.83). Embodiments of this invention can predict this without actually executing the federated learning system by examining modeling accuracy A→D (32.45) and D→A (41.39)

Referring still to FIG. 10, as another example, computing and evaluating peak modeling accuracy results in uncovering that combining Party D with Party C in a federated learning system would result in a peak modeling accuracy of 75.9, which is only a slight improvement over Party C's local ML model trained on Party C's local test set (73.35), and which is also only as slight improvement over Party D's local ML model trained on Party D's local test set (75.67). Accordingly, embodiments of the invention conclude that there is little benefit to training Party D with Party C in a federated learning system, i.e., there is only a slight benefit to running a federated learning system among parties within a cluster (cluster 1010B in this example).

Referring still to FIG. 10, and with reference to the peak modeling accuracy comparisons described above, embodiments of the invention improve the efficiency in federated learning systems (e.g., federated learning system 100) by comparing modeling accuracies delivered by different combinations of federated parties and selecting combinations that provide a desired modeling efficiency with the fewest members, which results in fewer communications in the federated learning system. For example, the combinations of “D+(A+B+C)=89.7”, “D+(A)=88.5” and “D+(B)=89.1” provide very similar peak federated learning accuracy. Accordingly communications congestion in the final federated learning system can be reduced by selecting either the combination of Party D with Party A or the combination of Party D with Party B instead of the combination of Party D with Parties A-C.

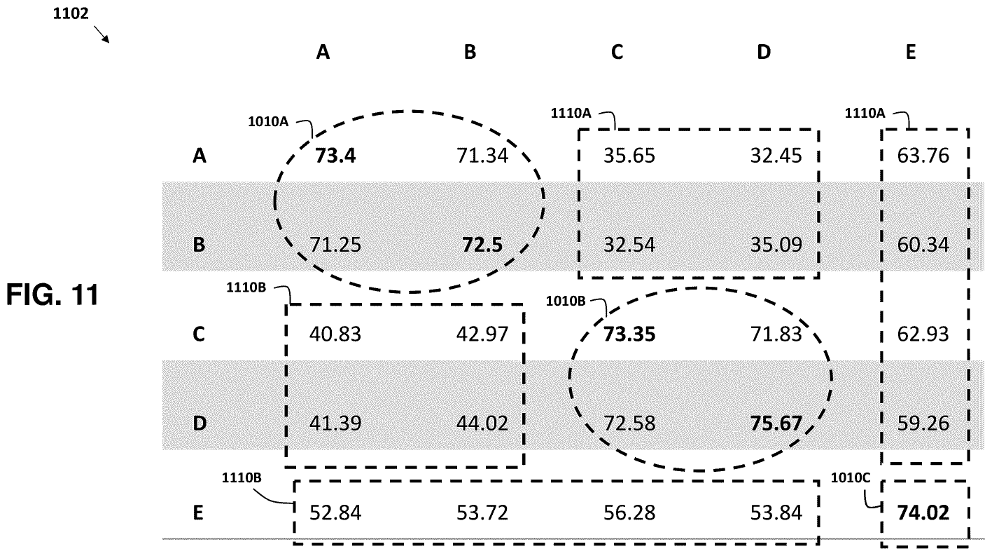

FIG. 11 illustrates a comparison table/matrix 1102 that corresponds to the comparison matrix/table 1002 (shown in FIG. 10) but provides an identification (e.g., using the matchmaker code 310, 330, 610 shown in FIGS. 3 and 6) of additional cluster regions 1110A, 1110B that have substantially similar computed modeling accuracies. Embodiments of the invention draw inferences from the observation that cluster regions 1110A, 1110B have substantially similar computed modeling accuracies, including the inference that there is little benefit from training a federated learning system constructed solely from a combination of the Parties that fall within the cluster regions 1110A, 1110B. Additionally, embodiments of the invention draw the inference from cluster regions 1110A, 1110B that Party A's local ML model and Party B's local ML model do not perform well on Party C's data or Party D's data; and that Party C's local ML model and Party D's local ML model do not perform well on Party A's data or Party B's data. Substantially the same peak modeling accuracy analysis applied to the cluster regions shown in the table/matrix 1002 (shown in FIG. 10) can be applied to the cluster regions shown in the table 1102.

FIG. 12 illustrates an example of a computer system 1200 that can be used to implement the computer-based components of the neural network system described herein. The computer system 1200 includes an exemplary computing device (“computer”) 1202 configured for performing various aspects of the content-based semantic monitoring operations described herein in accordance aspects of the invention. In addition to computer 1202, exemplary computer system 1200 includes network 1214, which connects computer 1202 to additional systems (not depicted) and can include one or more wide area networks (WANs) and/or local area networks (LANs) such as the Internet, intranet(s), and/or wireless communication network(s). Computer 1202 and additional system are in communication via network 1214, e.g., to communicate data between them.

Exemplary computer 1202 includes processor cores 1204, main memory (“memory”) 1210, and input/output component(s) 1212, which are in communication via bus 1203. Processor cores 1204 includes cache memory (“cache”) 1206 and controls 1208, which include branch prediction structures and associated search, hit, detect and update logic, which will be described in more detail below. Cache 1206 can include multiple cache levels (not depicted) that are on or off-chip from processor 1204. Memory 1210 can include various data stored therein, e.g., instructions, software, routines, etc., which, e.g., can be transferred to/from cache 1206 by controls 1208 for execution by processor 1204. Input/output component(s) 1212 can include one or more components that facilitate local and/or remote input/output operations to/from computer 1202, such as a display, keyboard, modem, network adapter, etc. (not depicted).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 13, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 13 are intended to be illustrative only and that computing nodes 10 and cloud computing environment 50 can communicate with any type of computerized device over any type of network and/or network addressable connection (e.g., using a web browser).

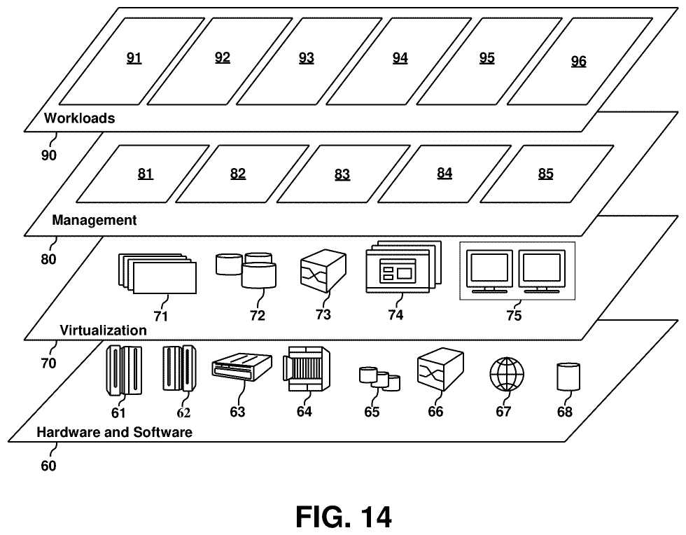

Referring now to FIG. 14, a set of functional abstraction layers provided by cloud computing environment 50 (FIG. 13) is shown. It should be understood in advance that the components, layers, and functions shown in FIG. 14 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the secure and reliable benefit-analysis matchmaking to select candidates for federated learning 96.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

Many of the functional units described in this specification are illustrated as logical blocks such as classifiers, modules, servers, processors, and the like. Embodiments of the invention apply to a wide variety of implementations of the logical blocks described herein. For example, a given logical block can be implemented as a hardware circuit operable to include custom VLSI circuits or gate arrays, as well as off-the-shelf semiconductors such as logic chips, transistors, or other discrete components. The logical blocks can also be implemented in programmable hardware devices such as field programmable gate arrays, programmable array logic, programmable logic devices, and the like. The logical blocks can also be implemented in software for execution by various types of processors. Some logical blocks described herein can be implemented as one or more physical or logical blocks of computer instructions which can, for instance, be organized as an object, procedure, or function. The executables of a logical block described herein need not be physically located together but can include disparate instructions stored in different locations which, when joined logically together, include the logical block and achieve the stated purpose for the logical block.

Many of the functional units of the systems described in this specification have been labeled as models. Embodiments of the invention apply to a wide variety of model implementations. For example, the models described herein can be implemented by machine learning algorithms and natural language processing algorithms configured and arranged to uncover unknown relationships between data/information and generate a model that applies the uncovered relationship to new data/information in order to perform an assigned task of the model.

The various components, modules, sub-function, and the like of the systems illustrated herein are depicted separately for ease of illustration and explanation. In embodiments of the invention, the operations performed by the various components, modules, sub-functions, and the like can be distributed differently than shown without departing from the scope of the various embodiments of the invention described herein unless it is specifically stated otherwise.

For convenience, some of the technical operations described herein are conveyed using informal expressions. For example, a processor that has key data stored in its cache memory can be described as the processor “knowing” the key data. Similarly, a user sending a load-data command to a processor can be described as the user “telling” the processor to load data. It is understood that any such informal expressions in this detailed description should be read to cover, and a person skilled in the relevant art would understand such informal expressions to cover, the informal expression's corresponding more formal and technical description.

Embodiments of the invention utilize various types of artificial neural networks, which are modeled after the functionality of biological neurons in the human brain. In general, a biological neuron has pathways that connect it to upstream inputs, downstream outputs, and downstream “other” neurons. Each biological neuron sends and receives electrical impulses through pathways. The nature of these electrical impulses and how they are processed in the biological neuron are primarily responsible for overall brain functionality. The pathway connections between the biological neurons can be strong or weak. When the neuron receives input impulses, the neuron processes the input according to the neuron's function and sends the result of the function on a pathway to downstream outputs and/or on a pathway to downstream “other” neurons. A normal adult human brain includes about one hundred billion interconnected neurons.

In artificial neural networks, the biological neuron is modeled as a node having a mathematical function, f(x). Each node in the neural network receives electrical signals from inputs over one of multiple pathways, multiplies each input by the strength of its respective connection pathway, takes a sum of the inputs, passes the sum through a function (f(x)) of the node, and generates a result, which may be a final output or an input to another node, or both. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

In general, neural networks can be implemented as a set of algorithms (e.g., machine learning algorithms) running on a programmable computer (e.g., computer systems 1200 shown in FIG. 12). In some instances, neural networks are implemented on an electronic neuromorphic machine (e.g., the IBM®/DARPA SyNAPSE computer chip) that attempts to create connections between processing elements that are substantially the functional equivalent of the synapse connections between brain neurons. In either implementation, neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

The basic function of a neural network is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The neural network creates a “model” that is “trained” by performing multiple iterations of learning-based analysis on the real-world data vectors until patterns (or relationships) contained in the real-world data vectors are uncovered and learned. The patterns uncovered/learned by the model of the neural network can be used to perform a variety of tasks. The learning or training performed by the machine learning algorithms on the model can be supervised, unsupervised, or a hybrid that includes aspects of supervised and unsupervised learning. Supervised learning is when training data is already available and classified/labeled. Unsupervised learning is when training data is not classified/labeled so must be developed through iterations of the neural network and the machine learning algorithms. Unsupervised learning can utilize additional learning/training methods including, for example, clustering, anomaly detection, neural networks, deep learning, and the like.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
using a processor system to access a first machine learning (ML) model that has been trained using data of a first server;
using the processor system to determine a first performance metric of the first ML model using data of a second server; and
performing a benefit analysis to determine a benefit of the first server and the second server participating in a federated learning system;
wherein the benefit analysis includes using the first performance metric.

2. The computer-implemented method of claim 1 further comprising:
using the processor system to access a second ML model that has been trained using the data of the second server; and
using the processor system to determine a second performance metric of the second ML model using the data of the first server;
wherein the benefit analysis further includes using the second performance metric.

3. The computer-implemented method of claim 2, wherein:
the determination of the first performance metric of the first ML model using the data of the second server is performed within a first trusted execution environment (TEE); and
the determination of the second performance metric of the second ML model using the data of the first server is performed within a second TEE.

4. The computer-implemented method of claim 3 further comprising, subsequent to performing the benefit analysis:
deleting from the first TEE the first ML model and the data of the second server; and
deleting from the second TEE the second ML model and the data of the first server.

5. The computer-implemented method of claim 2, wherein:
the determination of the first performance metric of the first ML model using the data of the second server is performed within a trusted execution environment (TEE); and
the determination of the second performance metric of the second ML model using the data of the first server is performed within the TEE.

6. The computer-implemented method of claim 5 further comprising, subsequent to performing the benefit analysis, deleting from the TEE:
the first ML model;
the data of the second server;
the second ML model; and
the data of the first server.

7. The computer-implemented method of claim 5, wherein the TEE is implemented in a cloud computing server.

8. A computer system comprising a processor system communicatively coupled to memory, wherein the processor system is operable to perform processor system operations comprising:
accessing a first machine learning (ML) model that has been trained using data of a first server;
determining a first performance metric of the first ML model using data of a second server; and
performing a benefit analysis to determine a benefit of the first server and the second server participating in a federated learning system;
wherein the benefit analysis includes using the first performance metric.

9. The computer system of claim 8, wherein the processor system operations further comprise:
accessing a second ML model that has been trained using the data of the second server; and
determining a second performance metric of the second ML model using data of the first server;
wherein the benefit analysis further includes using the second performance metric.

10. The computer system of claim 9, wherein:
the determination of the first performance metric of the first ML model using the data of the second server is performed within a first trusted execution environment (TEE); and
the determination of the second performance metric of the second ML model using the data of the first server is performed within a second TEE.

11. The computer system of claim 10, wherein the processor system operations further comprise, subsequent to performing the benefit analysis:
deleting from the first TEE the first ML model and the data of the second server; and
deleting from the second TEE the second ML model and the data of the first server.

12. The computer system of claim 9, wherein:
the determination of the first performance metric of the first ML model using the data of the second server is performed within a trusted execution environment (TEE); and
the determination of the second performance metric of the second ML model using the data of the first server is performed within the TEE.

13. The computer system of claim 12, wherein the processor system operations further comprise, subsequent to performing the benefit analysis, deleting from the TEE:
the first ML model;
the data of the second server;
the second ML model; and
the data of the first server.

14. The computer system of claim 8, wherein the benefit comprises a difference between:
a first benefit that incurs to the first server based on the first server participating in the federated learning system; and
a second benefit that incurs to the second server based on the second server participating in the federated learning system.

15. A computer program product for performing matchmaking operations on federated learning candidates, the computer program product comprising a computer readable program stored on a computer readable storage medium, wherein the computer readable program, when executed on a processor system, causes the processor system to perform a method comprising:
accessing a first machine learning (ML) model that has been trained using data of a first server;
determining a first performance metric of the first ML model using data of a second server; and
performing a benefit analysis to determine a benefit of the first server and the second server participating in a federated learning system;
wherein the benefit analysis includes using the first performance metric.

16. The computer program product of claim 15, wherein the method further comprises:
accessing a second ML model that has been trained using the data of the second server; and
determining a second performance metric of the second ML model using the data of the first server; and
wherein the benefit analysis further includes using the second performance metric.

17. The computer program product of claim 16, wherein:
the determination of the first performance metric of the first ML model using the data of the second server is performed within a first trusted execution environment (TEE); and
the determination of the second performance metric of the second ML model using the data of the first server is performed within a second TEE.

18. The computer program product of claim 17, wherein the method further comprises, subsequent to performing the benefit analysis:
deleting from the first TEE the first ML model and the data of the second server; and
deleting from the second TEE the second ML model and the data of the first server.

19. The computer program product of claim 16, wherein:
the determination of the first performance metric of the first ML model using the data of the second server is performed within a trusted execution environment (TEE);
the determination of the second performance metric of the second ML model using the data of the first server is performed within the TEE.

20. The computer program product of claim 19, wherein the method further comprises, subsequent to performing the benefit analysis, deleting from the TEE:
the first ML model;
the data of the second server;
the second ML model; and
the data of the first server.
